(19) United States
(12) Patent Application Publication
(10) Pub. No.: US 2025/0231280 A1
(43) Pub. Date: Jul. 17, 2025

(54) Radome Device for a Radar Sensor of a Vehicle, Comprising a Heating Element for Controlling the Temperature of a Preferred Accumulation Region, Method for Operating a Heating Element of a Radome Device

(71) Applicant: Bayerische Motoren Werke Aktiengesellschaft, Muenchen (DE)

(72) Inventor: Jonathan ROTH, Muenchen (DE)

(21) Appl. No.: 18/854,598

(22) PCT Filed: Apr. 3, 2023
(86) PCT No.: PCT/EP2023/058616

§ 371 Date: Oct. 7, 2024

(30) Foreign Application Priority Data
Apr. 25, 2022 (DE) 10 2022 109 904.0

(51) Int. Cl. G01S 7/40; G01S 7/03; G01S 13/931

(52) U.S. Cl. CPC G01S 7/4047; G01S 7/03; G01S 13/931; G01S 2013/93271

(57) ABSTRACT

A radome device for a radar sensor of a vehicle has a radome with a central region which is permeable to electromagnetic radiation from the radar sensor. The radome device includes a heating element for controlling the temperature of a central region of the radome, wherein a heat output can be introduced into the central region of the radome by way of electrical energy. The central region has a preferred accumulation region, within which precipitation from the surroundings of the vehicle preferably accumulates when the radome device is arranged on the vehicle as intended. An overall heat output that is different from the heat output can be introduced into the preferred accumulation region.

### BACKGROUND AND SUMMARY

The present invention relates to a radome device for a radar sensor of a vehicle, comprising a heating element for controlling the temperature of a preferred accumulation region. Furthermore, the present invention relates to a method for operating a heating element of a radome device for a radar sensor that comprises at least a first electric heating circuit and a second electric heating circuit.

Vehicles that have modern driver assistance systems often comprise radar sensors, which serve, for example, to detect objects in the environment the vehicle. In particular, such radar sensors are used together with adaptive cruise control systems. These radar sensors are covered by a radome and protected from environmental influences. Particularly in the case of cold weather conditions in conjunction with precipitation, an accumulation may form on the radome. The accumulation of precipitation may adversely affect the functional capability of the radar sensor, and consequently of the driver assistance system.

Known from the prior art, in order to counter this problem, are heating means and heating elements for radomes of radar sensors. These heating elements enable the radome to be heated, or its temperature to be controlled. According to the prior art, the heating means are controlled, for example, in dependence on the ambient temperature. It may be provided, for example, that the heating element be activated in a temperature range of from −5° C. to +5° C. Typically, for this purpose there is a heating conductor that extends inside the radome and serves to control the temperature of the radome of the radar sensor accordingly, or to heat it. According to the prior art, the strip conductors of the heating conductor, or the wires in the case of a heating wire, are distributed evenly within the radome, or are distributed symmetrically in the radome.

The published patent application DE 10 2017 221 589 A1 discloses a heating system for a radome of a radar for a motor vehicle, the heating system comprising a heating element for heating the radome, and a control unit, connected to the heating element, for activating the heating element. The control unit is configured to receive or determine a variable that is characteristic of an outside temperature, to receive or determine a variable associated with a melting point of precipitation accumulations on an outer radome surface, to determine at least one temperature threshold value in dependence on the variable associated with the melting point, and to activate the heating element in dependence on a threshold-value comparison of the outside temperature with the temperature threshold value.

The publication DE 10 2011 054 645 A1 describes a heatable window, in particular a vehicle window, having an upper and a lower window edge, as well as lateral window edges, a transparent field of vision that has a central main field of vision, a set of heating wires arranged at least partially in the field of vision and extending between group contact strips of differing polarity, and a lower heating-field region arranged along the lower window edge, beneath the main field of vision, and having at least some of the heating wires. The heatable window is characterized in this case by an upper heating-field region comprising at least some of the heating wires and arranged at least partially in the transparent field of vision and along the upper edge of the window, above the main field of vision, the heating wires, in the upper heating-field region, extending in a non-crossed manner with respect to one another and substantially parallel to the upper edge of the window in their direction of main extent, at least over the predominant distance of extent. In particular, in this case it is possible to provide a ring heater, formed of heating wires, that surrounds the main field of vision.

The object of the present invention is to provide a solution as to how controlling the temperature of a radome may be further improved in comparison with the prior art.

This object is achieved according to the invention by a radome device for a radar sensor of a vehicle, and by a method for operating a heating element of a radome device, having the features according to the independent claims. Advantageous developments of the present invention are given in the dependent claims.

A radome device according to the invention for a radar sensor of a vehicle comprises a radome having a central region that is permeable to electromagnetic radiation of the radar sensor. Additionally, a radome device according to the invention comprises a heating element for controlling the temperature of the central region of the radome, wherein a heat output can be introduced into the central region of the radome by means of electrical energy. The central region in this case has a preferred accumulation region, within which precipitation from an environment of the vehicle preferentially accumulates when the radome device is arranged on the vehicle in a proper manner. Additionally, an overall heat output that is different from the heat output can be introduced in the preferred accumulation region.

By means of the radome device according to the invention, precipitation from the environment of the vehicle is to be prevented from accumulating on the radome of the radome device. The radome serves in this case as a cover for the radar sensor, and thus protects the radar sensor from environmental influences. The radome in this case may be formed by a region of a fender of the vehicle, an emblem and/or a paneling element of the vehicle. The radome in this case may have a central region that is permeable to electromagnetic radiation of the radar sensor. In other words, the radar sensor may thus transmit and/or receive the electromagnetic radiation through the central region of the radome.

In particular, in the case of the radome device being arranged in an off-center manner on the vehicle, as the proper arrangement of the radome device on the vehicle, it is intended that an improved discharge and/or removal of the accumulation of precipitation be made possible by means of the radome device according to the invention. Due to the geometric design of the radome, or of the radome device and/or of an outer skin of the vehicle surrounding the radome device, a build-up point may form in an area of the central region. Due to such a build-up point, which may result from the design requirements for the vehicle, precipitation from the environment may accumulate in the build-up point. This may be the case, in particular, if the radar sensor, or the radome device, is installed off-center. In other words, the precipitation from the environment of the vehicle may preferentially accumulate within a preferred accumulation region within the central region of the radome.

The preferred accumulation region may be determined, for example, by means of aerodynamic flow simulations. Preferably, the preferred accumulation region may thus be determined during an early development phase of the vehicle, such that the preferred accumulation region can also be taken into consideration in an early development phase of the radar sensor. Additionally, it is contemplated to determine the preferred accumulation region as part of wind tunnel tests. Finally, the preferred accumulation region may also be determined as part of test drives, in particular as part of winter trials.

The heating element of the radome device serves to control the temperature of the central region. By means of the radome device according to the invention, an overall heat output that is different from the heat output may now be introduced in the preferred accumulation region. In other words, the heat output in the central region of the radome is thus not distributed uniformly. In particular, the overall heat output in the preferred accumulation region may thus be greater than the heat output outside of the preferred accumulation region. It can thereby be ensured that the radome device, or the radome, is reliably relieved of the accumulation of precipitation, but without unnecessary introduction of an increased heat output outside of the preferred accumulation region.

Precipitation from the environment of the vehicle may accumulate on the radome, in particular at ambient temperatures below freezing. For example, ice, snow, slush, hail, sleet or the like may accumulate. Additionally, it is contemplated that fog or water could also accumulate on the radome or radome device. The accumulation of precipitation may result in the transmission and/or reception of the electromagnetic radiation of the radar sensor through the radome, or through the central region, being negatively affected. To enable this accumulation of precipitation to be removed from the radome, the heating element is activated. A heat output may be introduced in the central region of the radome, in this case by means of electrical energy. As a result, the temperature of the central region of the radome can be controlled. In order to activate the heating element, a voltage may be applied to the heating element, and/or an electric current may flow through the heating element.

According to the present radome device of the invention, it is provided in an advantageous design that the heating element be realized as a heating conductor, wherein the heating conductor is arranged, substantially orthogonally with respect to a polarization of the electromagnetic radiation of the radar sensor, in the central region of the radome. This heating conductor may be realized, for example, as a heating wire, heating foil and/or heating plate. If the heating conductor is arranged orthogonally with respect to a polarization of the radar sensor, or to a polarization of the electromagnetic radiation of the radar sensor, the electromagnetic radiation of the radar sensor can pass more effectively through the heating element. In other words, the transmission and/or reception of the electromagnetic radiation of the radar sensor can thus be improved. If a voltage is applied to the heating conductor, and/or if an electrical current flows through the heating conductor, the electrical energy may be converted into the heat output that can be introduced into the central region of the radome.

According to the present invention, it is also provided that the heating element have at least a first electric heating circuit and a second electric heating circuit, wherein the temperature of the central region including/excluding the preferred accumulation region can be controlled by means of the first electric heating circuit, and the temperature of only the preferred accumulation region can be controlled by means of the second electric heating circuit. The first electric heating circuit may thus be used to introduce the heat output in the central region of the radome. By means of the second electric heating circuit, the overall heat output that is different from the heat output may be introduced in the preferred accumulation region. The use of a first electric heating circuit and a second electric heating circuit allows the temperature of the radome device to be controlled in an energy-efficient manner. In particular, an overall heat output that may be greater than the heat output may be introduced into the preferred accumulation region, such that the accumulation of precipitation, from the environment of the vehicle, in the build-up point, or in the preferred accumulation region, may be removed.

It is contemplated for the first electric heating circuit and the second electric heating circuit to control the temperature of mutually differing regions of the central region of the radome. It is also contemplated, however, for the first electric heating circuit to control the temperature the entire central region of the radome, such that the overall heat output consequently includes the heat output introduced by the first heating circuit as well as the heat output introduced by the second electric heating circuit.

In a further, alternative design of the radome device according to the invention, the overall heat output that is different from the heat output can be introduced in the preferred accumulation region by means of an inhomogeneous heating-conductor density distribution of the heating conductor. If the heating conductor is realized, for example, in the form of a heating wire, an increased number of heating wires, or a reduced distance between the heating wires, in the preferred accumulation region may ensure that an overall heat output that is different from the heat output of the central region can be introduced in the preferred accumulation region. A reduced distance between the heating wires in the preferred accumulation region may result in an increased heat-conductor density distribution in the preferred accumulation region. In other words, the heat-conductor density distribution of the heating conductor in the central region of the radome is inhomogeneous, as a result of which an overall heat output that is different from the heat output may be introduced within the preferred accumulation region.

Additionally or alternatively, in a further embodiment, the overall heat output that is different from the heat output may be introduced in the preferred accumulation region by means of an inhomogeneous heating-conductor cross-sectional distribution of the heating conductor. A heating-conductor cross-section of the heating conductor is indirectly proportional to an electrical resistance of the heating conductor. Variation of the heating-conductor cross-section of the heating conductor thus makes it possible to influence the amount of heat generated. For example, less heat may be generated at sites of the heating conductor that have a greater heating-conductor cross-section than at sites of the heating conductor that have a lesser heating-conductor cross-section. A reduced heating-conductor cross-section of the heating conductor in the preferred accumulation region thus enables an increased heat output, or an overall heat output that differs from the heat output, to be introduced in the preferred accumulation region. It may thereby be ensured that the accumulation of precipitation from the environment of the vehicle, which preferentially accumulates within the preferred accumulation region, can be removed in an energy-efficient manner by generation of an amount of heat that is greater than in the remaining the central range of the radome.

A method according to the invention for operating a heating element of a radome device for a radar sensor, that has at least a first electric heating circuit and a second electric heating circuit, comprises receiving environment data describing an environment of the vehicle and/or at least a central region of a radome of the radome device of the vehicle, wherein the central region is permeable to electromagnetic radiation of the radar sensor. Additionally, the method comprises recognizing, based on the environment data, a precipitation and/or an accumulation of the precipitation within the central region of the radome. Finally, the method according to the invention also comprises outputting a first heating signal to the heating element for the purpose of controlling the temperature of the radome by means of the first electric heating circuit, in dependence on the recognized accumulation of the precipitation. In this case, upon recognition of the precipitation and/or of the accumulation of the precipitation, a sub-region accumulation probability for a sub-region accumulation of the precipitation within a preferred accumulation region of the central region may additionally be determined. Thereupon, a second heating signal may additionally be output in dependence on the sub-region accumulation probability for the purpose of controlling the temperature of the radome by means of the second electric heating circuit.

By use of the method, the temperature of a radome device for the radar sensor is to be controlled by means of the heating element. When the radome device is arranged on the vehicle in a proper manner, a preferred accumulation region may form. Precipitation from the environment of the vehicle may preferentially accumulate in the preferred accumulation region. Within the preferred accumulation region, an increased heat output, as compared to the remaining region of the radome device, or as compared to the remaining central region of the radome of the radar device, may be necessary in order to remove the accumulation. It may be energy efficient in this case if a lesser heat output is introduced in the remaining region of the central region, i.e. in the central region excluding the preferred accumulation region, than in the preferred accumulation region. In other words, it may be energy efficient if the second electric heating circuit is activated only when an increased accumulation of precipitation, in the form of sub-region accumulation, is to be expected and/or is recognized in the preferred accumulation region. The sub-region accumulation may also be an accumulation identical to the recognized precipitation and/or to the recognized accumulation of precipitation within the central region. It is therefore possible for the sub-region accumulation probability to be determined indirectly and independently of an actual sub-region accumulation.

The sub-region accumulation probability in this case may indicate a probability for the accumulation of precipitation within the preferred accumulation region. However, the sub-region accumulation probability may also indicate a confidence for the recognized precipitation and/or the recognized accumulation of precipitation.

The method may be performed by use of a computing device of the vehicle. This computing device may be constituted by at least one electronic control device comprising one or more programmable processors. This computing device may be used to receive the environment data. These environment data may describe the environment of the vehicle, or a region of the environment of the vehicle. Alternatively or additionally, the environment data may describe the radome itself, or the central region of the radome, or a part thereof. Based on the environment data, the computing device may ascertain whether there is an accumulation of precipitation on the radome, or in the central region of the radome. In order to remove this accumulation of precipitation from the central region of the radome, the computing device may output a first heating signal to the heating element. By means of the first heating signal, the first electric heating circuit may be activated. Additionally, the computing device may output a second heating signal.

According to the method of the invention, it is provided that at least temperature data and/or air humidity data, describing a temperature and/or air humidity in the environment of the vehicle, be received as the environment data. The precipitation may be characterized in this case on the basis of the temperature data and/or humidity data. For example, the precipitation may be characterized as ice, snow, slush, hail, sleet, fog, water or the like. The first heating signal and/or the second heating signal may thus additionally be output in dependence on the characterized precipitation.

The temperature data may be received, for example, from a temperature sensor that describes the temperature in the environment of the vehicle and/or the radome. The air humidity data may be received, for example, from an air humidity sensor that describes the air humidity in the environment of the vehicle and/or the radome. It is also possible, however, for the temperature data and/or humidity data to be received or accessed from a weather service. The probability of the precipitation in the environment of the vehicle accumulating at the central region of the radome may be inferred on the basis of these temperature data and/or humidity data. For example, in the case of low temperature and low air humidity, powdery snow may be inferred. In such a case, there may be a lesser probability of the precipitation accumulating on the radome device. In contrast, in the case of high air humidity and a temperature just above the freezing point of water, an increased probability of accumulation of precipitation from the environment of the vehicle may be inferred. This may also influence the sub-region accumulation probability.

A further design of the method according to the invention additionally provides that at least image data from a camera of the vehicle be received as the environment data, and the precipitation in the environment and/or the accumulation of the precipitation within the central region of the radome be recognized on the basis of the image data. The image data may comprise a digital image or a sequence. In particular, the image data may describe the visible wavelength range. The image data may be provided by a camera of the vehicle. The image data in this case may describe the precipitation present in the environment. For example, the image data may be used to determine whether ice or snow is present in the environment. Alternatively or additionally, the image data may describe the central region of the radome, or the radome itself, or a range thereof. A camera of the vehicle, in the detection range of which the radome is at least partially located, may be used to provide such image data.

It is therefore provided that the image data from the camera be used, the latter usually being present on modern vehicles in any case. This means that it may not be necessary to install an additional sensor. The image data may thus be used to regulate the heating element. Thus, overall, the heating element of the radome can be easily operated in an energy-efficient manner.

Preferably, the precipitation is additionally characterized on the basis of the image data, wherein the image data describe the precipitation on, next to and/or over a roadway in the environment. The first heating signal and/or the second heating signal may thus additionally be output in dependence on the characterized precipitation.

Finally, a further design of the method according to the invention provides that radar data of the radar sensor be additionally received and, on the basis of the radar data, vehicle-following travel, in which a further road user is travelling in front of the vehicle, be recognized, and the first heating signal and/or the second heating signal be additionally output in dependence on the recognized vehicle-following travel. Alternatively, vehicle-following travel may also be recognized by means of a camera of the vehicle and/or further sensors. Vehicle-following travel describes the traffic situation in which the further road user is in front of the vehicle and travelling in the same direction. In particular, in the case of this vehicle-following travel, precipitation that has accumulated on the roadway may be swirled-up by the wheels of the road user's vehicle and deposited on the radome, or in the central region of the radome. In the case of such vehicle-following travel with swirled-up precipitation, the probability of precipitation accumulating in the central region of the radome may increase. In particular, the sub-region accumulation probability may also increase. The temperature, air humidity and/or the like may also be taken into consideration in this regard.

A computing device according to the invention for a vehicle is configured to execute a method according to the invention and the advantageous designs thereof. The computing device may be realized, for example, as an electronic control device comprising one or more programmable processors.

A computer-readable (memory) medium according to the invention comprises instructions which, when executed by a computing device, cause the computing device to execute a method according to the invention and the advantageous designs thereof.

A further aspect of the invention relates to a computer program comprising instructions which, when the program is executed by a computing device, cause the computing device to execute a method according to the invention and the advantageous designs thereof. Furthermore, the invention relates to a vehicle comprising a radome device according to the invention for a radar sensor. The vehicle may be realized, in particular, as a passenger car.

The embodiments presented and preferred with respect to the method according to the invention, and their advantages, apply accordingly to the computing device according to the invention, to the computer-readable (memory) medium according to the invention, to the computer program according to the invention and to the vehicle according to the invention.

Further features of the invention are apparent from the claims, the figures and the description of the figures. The aforementioned features and combinations of features mentioned in the description, as well as the features and combinations of features mentioned below in the description of the figures and/or shown alone in the figures, can be used not only in the combination indicated in each case, but also in other combinations or on their own, without departing from the scope of the invention.

The invention will now be explained in more detail with reference to preferred exemplary embodiments and with reference to the accompanying drawings.

### BRIEF DESCRIPTION OF THE DRAWINGS

FIGS. 1a, b are schematic representations of a vehicle, comprising the radome device according to an embodiment of the invention;

FIG. 2 is a schematic representation of a vehicle, comprising a radome device that has a stylized preferred accumulation region;

FIG. 3 is a schematic representation of an exemplary embodiment of a radome device according to the invention;

FIGS. 4a-c are schematic representations of various exemplary embodiments of a radome device according to the invention, with corresponding designs of a heating conductor; and

FIG. 5 shows the vehicle of FIG. 1 during vehicle-following travel, in which there is a further road user in front of the vehicle.

In the figures, elements that are identical or functionally identical are denoted by the same reference designations.

### DETAILED DESCRIPTION OF THE DRAWINGS

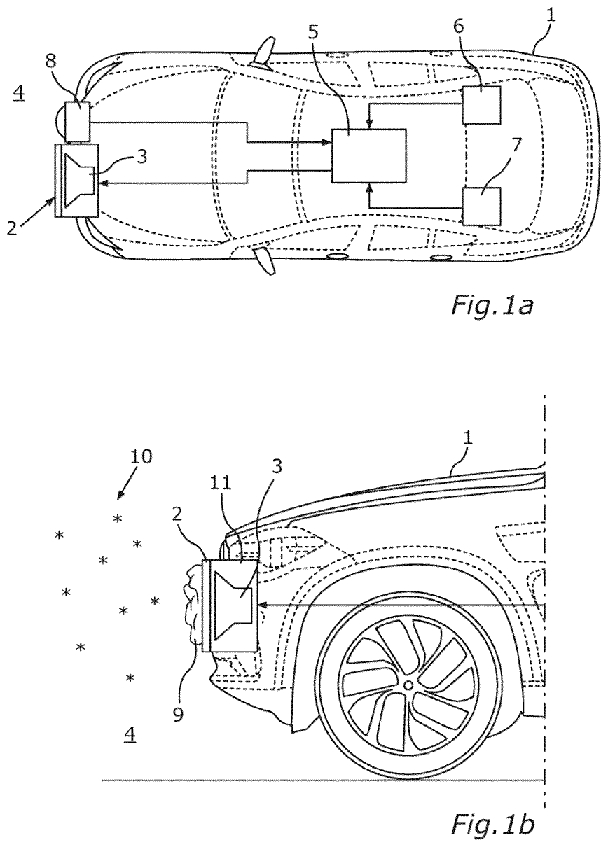

FIG. 1a shows a schematic representation of a vehicle 1, realized as a passenger car, in a top view. The vehicle 1 comprises a radome device 2. This radome device 2 serves to protect a radar sensor 3 from environmental influences from an environment 4 of the vehicle 1. The vehicle 1 additionally comprises a computing device 5, as well as a temperature sensor 6 and a humidity sensor 7. Finally, the vehicle 1 comprises a camera 8, which in the example is arranged at the front of the vehicle 1.

FIG. 1b shows a schematic representation of the vehicle 1 in an enlarged side view. In particular, FIG. 1b shows the radome device 2, the radar sensor 3 and an accumulation 9 of precipitation 10—represented here in the form of snowflakes—from the environment 4 of the vehicle 1. The radar sensor 3 may be arranged in a housing 11. To protect it from environmental influences from the environment 4 of the vehicle 1, the radar sensor 3 may be protected by means of the radome device 2. In the case of low temperatures in the environment 4, which may be detected by means of the temperature sensor 6, precipitation 10 may accumulate on the radome device 2. This accumulation 9 may adversely affect the transmission and/or reception of electromagnetic radiation of the radar sensor 3.

By means of a heating element 16, the temperature of a central region 13 of the radome device 2 may be controlled, such that the accumulation 9 of precipitation 10 from the environment 4 of the vehicle 1 is removed. By means of the camera 8, it may be recognized whether there is precipitation 10 present in the environment 4 of the vehicle 1 and/or whether an accumulation of the precipitation 10 occurs within the central region 13 of the radome 14 of the radome device 2. Whether an accumulation 9 of precipitation 10 occurs on the radome device 2 may be dependent on the air humidity in the environment 4 of the vehicle 1. The air humidity may be measured by means of the humidity sensor 7.

In dependence on the precipitation 10 recognized and/or the accumulation 9 of the precipitation 10 and/or the temperature in the environment 4 provided by the temperature sensor 6 and/or the temperature of the radome device 2 and/or the air humidity of the environment 4 provided by the air humidity sensor 7, the computing device 5 may output a first heating signal and/or a second heating signal to the heating element 16 of the radome device 2. The accumulation 9 may thereby be removed from the radome device 2.

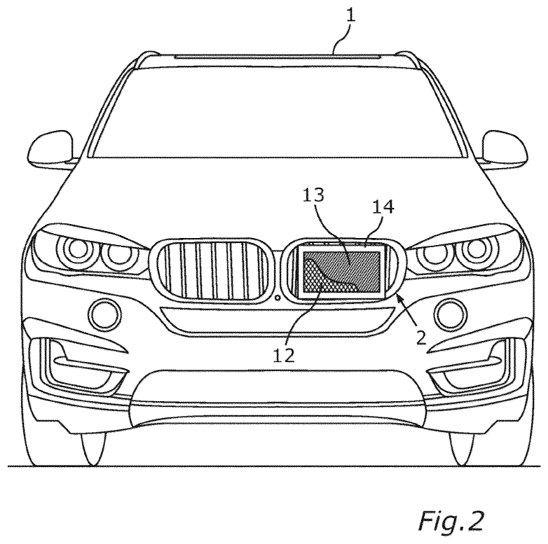

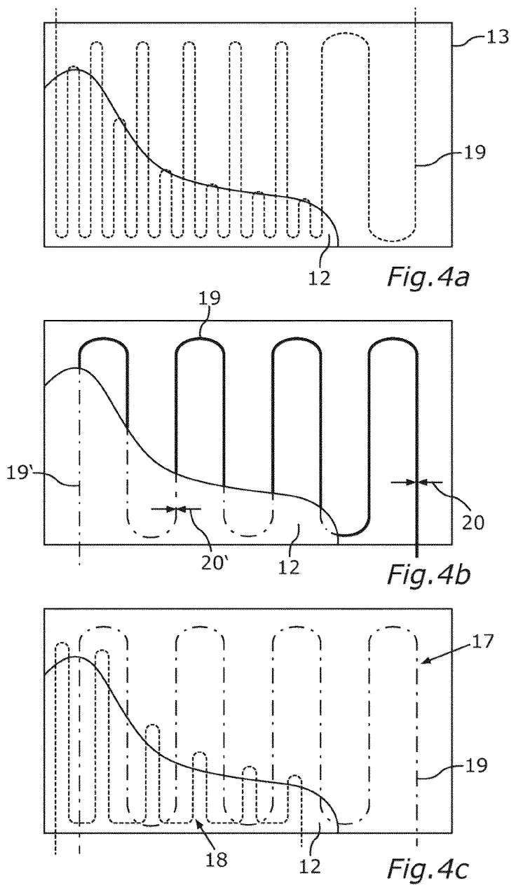

FIG. 2 shows a schematic representation of the vehicle 1 in a frontal view. For the sake of clarity, only the radome device 2 is represented. The radome device 2 in this case is arranged off-center in the radiator grille of the vehicle 1. Due to such an off-center arrangement of the radome device 2, it may happen that the precipitation 10 from the environment 4 of the vehicle 1 accumulates asymmetrically on the radome device 2. In FIG. 2, such an asymmetric accumulation 9 is represented by a preferred accumulation region 12 within the central region 13 of the radome 14 of the radome device 2. The accumulation 9 of the precipitation 10 may therefore occur to a greater extent within the preferred accumulation region 12. In other words, more precipitation 10 may accumulate in the preferred accumulation region 12 than in the remaining central region 13. Consequently, in terms of energy efficiency, there is no need for an evenly distributed heat output within the central region 13. By means of the radome device 2 according to the invention, an overall heat output that is different from the heat output in the central region 13 may be introduced in the preferred accumulation region 12. Technical exemplary embodiments of how an overall heat output that is different from the heat output can be introduced into the preferred accumulation region 12 are given in the description relating to FIGS. 4a-c.

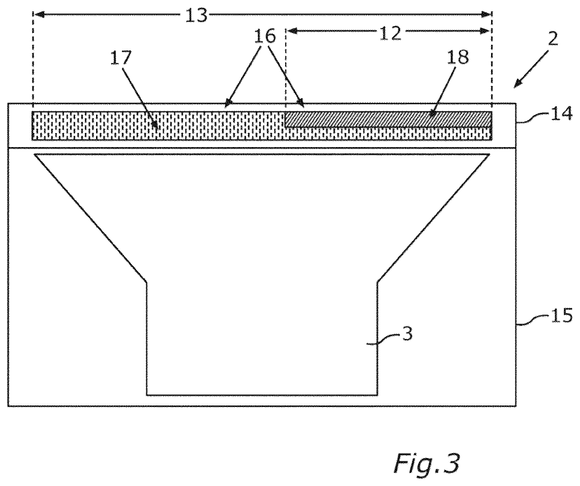

FIG. 3 shows a schematic representation of an exemplary embodiment of the radome device 2 according to the invention. This radome device 2 comprises the radome 14 with the central region 13. The central region 13 has a preferred accumulation region 12. The radome device 2 serves to protect the radar sensor 3 from environmental influences from the environment 4 of the vehicle 1. The radar sensor 3 in this case may be arranged in a housing 15.

The heating element 16 may have a first electric heating circuit 17 and a second electric heating circuit 18. By means of the first electric heating circuit 17, which in FIG. 3 is represented by a vertical hatching, the temperature of the central region 13, including the preferred accumulation region 12, may be controlled. In the exemplary embodiment of FIG. 3, only the temperature of the preferred accumulation region 12 may be controlled by means of the second electric heating circuit 18. By means of the first electric heating circuit 17, therefore, the heat output may be introduced into the central region 13, including the preferred accumulation region 12 of the radome 14. The overall heat output that is different from the heat output may be introduced into the preferred accumulation region 12 by means of the additional, second electric heating circuit 18. The overall heat output in this case may comprise the heat output of the central region 13 and—as represented in FIG. 3—the heat output introduced by the second electric heating circuit 18. In the exemplary embodiment of FIG. 3, the heat output introduced by the second electric heating circuit 18 is represented by the diagonal hatching. In general, however, it is also contemplated for the overall heat output to be introduced exclusively by means of the second electric heating circuit 18.

FIGS. 4a-c show various exemplary embodiments for an arrangement of a heating conductor 19 within the central region 13 of the radome 14. The preferred accumulation region 12 may have, for example—as represented in FIG. 4a—more strip conductors of the heating conductor 19 than the remainder of the central region 13. This may result in an inhomogeneous heating-conductor density distribution of the heating conductor 19 in FIG. 4a. In other words, the overall heat output that is different from the heat output can be introduced into the preferred accumulation region 12 by means of an inhomogeneous heating-conductor density distribution of the heating conductor 19.

In FIG. 4b, the overall heat output that is different from the heat output may be introduced into the preferred accumulation region 12 by means of an inhomogeneous heating-conductor cross-sectional distribution of the heating conductor 19. For example, outside of the preferred accumulation region 12, the heating conductor cross-section 20 of the heating conductor 19 may be greater than the heating-conductor cross-section 20′ of the heating conductor 19′.

An increased heating-conductor cross-section 20 of the heating conductor 19 outside of the preferred accumulation region 12 may reduce an electrical resistance, or a specific electrical resistance, of the heating conductor 19. As a result, there may be a lesser control the temperature of the region of the central region 13 that does not include the preferred accumulation region 12 than of the preferred accumulation region 12.

Finally, FIG. 4c shows a possible embodiment of the heating element 16 of FIG. 3. A first electric heating circuit 17 may extend within the central region 13. A second electric heating circuit 18 may extend within the preferred accumulation region 12. By combination of the first electric heating circuit 17 and the second heating circuit 18, an overall heat output that is different from the heat output may be introduced in the preferred accumulation region 12. This makes it possible for temperature control of the radome device 2, or of the radome 14, to be greatest where precipitation 10 from the environment 4 of the vehicle 1 accumulates preferentially. In other words, the central region 13 of the radome 14 is heated precisely where there is preferred accumulation 9.

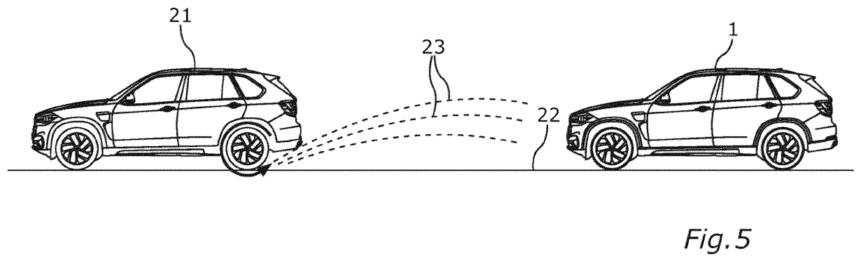

FIG. 5 shows a schematic representation of the vehicle of FIG. 1 during vehicle-following travel. In this vehicle-following travel, there is a further road user 21 travelling in front of the vehicle 1, with the vehicle 1 and the further road user 21 moving in the same direction of travel. In the example, the further road user 21 is also a passenger car. It is assumed that the precipitation 10 is present on a roadway 22 on which the vehicle 1 and the further road user 21 are present. For example, the precipitation 10 may be snow on the roadway 22. This precipitation 10 on the roadway 22 and next to the roadway 22 may be recognized on the basis of the image data from the camera 8.

Additionally, the precipitation 10 on the roadway 22 may be swirled up, or thrown up, by the wheels of the further road user 21 as they run on the roadway 22. This swirled-up precipitation 10 is illustrated here by the lines 23. This swirled-up precipitation 10 may also be recognized on the basis of the image data from the camera 8. The image data may be used to determine a probability of an accumulation 9 of the precipitation 10 on the radome 14. In addition, the precipitation 10 may be characterized on the basis of the temperature, the air humidity, the image data and/or the like.

1.-10. (canceled)

11. A radome device for a radar sensor of a vehicle, comprising:
a radome having a central region that is permeable to electromagnetic radiation of the radar sensor; and
a heating element for controlling a temperature of the central region of the radome, wherein
a heat output is introduced into the central region of the radome via electrical energy,
the central region has a preferred accumulation region, within which precipitation from an environment of the vehicle preferentially accumulates when the radome device is arranged on the vehicle as intended, and
an overall heat output that is different from the heat output is introduced into the preferred accumulation region.

12. The radome device according to claim 11, wherein
the heating element comprises a heating conductor, and
the heating conductor is arranged, substantially orthogonally with respect to a polarization of the electromagnetic radiation of the radar sensor, in the central region of the radome.

13. The radome device according to claim 12, wherein
the heating element has at least a first electric heating circuit and a second electric heating circuit,
the temperature of the central region, including or excluding the preferred accumulation region, is controllable by way of the first electric heating circuit, and the temperature of only the preferred accumulation region is controllable by way of the second electric heating circuit.

14. The radome device according to claim 12, wherein
the overall heat output that is different from the heat output is introduced into the preferred accumulation region via an inhomogeneous heating-conductor density distribution of the heating conductor.

15. The radome device according to claim 12, wherein
the overall heat output that is different from the heat output is introduced into the preferred accumulation region via an inhomogeneous heating-conductor cross-sectional distribution of the heating conductor.

16. A method for operating a heating element of a radome device for a radar sensor, the heating element having at least a first electric heating circuit and a second electric heating circuit, the method comprising the steps of:
receiving environment data describing an environment of the vehicle and/or describing at least a central region of a radome of the radome device of the vehicle, wherein the central region is permeable to electromagnetic radiation of the radar sensor;
recognizing, based on the environment data, a precipitation and/or an accumulation of the precipitation within the central region of the radome; and
outputting a first heating signal to the heating element for controlling the temperature of the radome via the first electric heating circuit, in dependence on the recognized accumulation of the precipitation,
wherein
upon recognition of the precipitation and/or of the accumulation of the precipitation, a sub-region accumulation probability for a sub-region accumulation of the precipitation within a preferred accumulation region of the central region is additionally determined, and
a second heating signal is additionally output in dependence on the sub-region accumulation probability for controlling the temperature of the radome via the second electric heating circuit.

17. The method according to claim 16, wherein
at least temperature data and/or air humidity data, describing a temperature and/or air humidity in the environment of the vehicle, are received as the environment data,
the precipitation is characterized on the basis of the temperature data and/or humidity data, and
the first heating signal and/or the second heating signal is/are additionally output in dependence on the characterized precipitation.

18. The method according to claim 17, wherein
at least image data from a camera of the vehicle are received as the environment data, and
the precipitation in the environment and/or the accumulation of the precipitation within the central region of the radome is/are recognized on the basis of the image data.

19. The method according to claim 18, wherein
the precipitation is additionally characterized based on the image data,
the image data describe the precipitation on, next to, and/or over a roadway in the environment, and
the first heating signal and/or the second heating signal is/are additionally output in dependence on the characterized precipitation.

20. The method according to claim 16, wherein
additional radar data of the radar sensor are received and, on the basis of the radar data, vehicle-following travel, in which a further road user is travelling in front of the vehicle, is recognized, and
the first heating signal and/or the second heating signal is/are additionally output in dependence on the recognized vehicle-following travel.

21. The method according to claim 16, wherein
at least image data from a camera of the vehicle are received as the environment data, and
the precipitation in the environment and/or the accumulation of the precipitation within the central region of the radome is/are recognized on the basis of the image data.
